(19) United States
(12) Patent Application Publication
(10) Pub. No.: US 2009/0207816 A1
(43) Pub. Date: Aug. 20, 2009

(54) Method for Ensuring the Service Platform the Acquisition of the User Terminal Information Under Multiple Application Protocols

(75) Inventors: Chunmei Zhu, Beijing (CN); Wei Wu, Beijing (CN); Jianfeng Tang, Beijing (CN)

Correspondence Address: Olson & Cepuritis, LTD., 20 NORTH WACKER DRIVE, 36TH FLOOR, CHICAGO, IL, 60606, US

(73) Assignee: China Mobile Communications Corporation, Xicheng District (CN)

(21) Appl. No.: 11/719,613

(22) PCT Filed: Sep. 29, 2005
(86) PCT No.: PCT/CN2005/001602

§ 371 Date: Apr. 6, 2009

(30) Foreign Application Priority Data
Nov. 19, 2004 (CN) 200410091560.9

(51) Int. Cl. H04W 4/00

(52) U.S. Cl. 370/338

(57) ABSTRACT

The present invention discloses a method for ensuring the service platform the acquisition of the user terminal information under multiple application protocols, wherein client terminal service connection software is set in the user terminal or the user card, and said client terminal service connection software has service connection user interface and is able to inspect and control the mobile service connection carried out by the mobile terminal. By adding the step of sending the general application protocol request to the proxy server before the service request of the user terminal, it is ensured that the service platform is still capable of acquiring the user's cellphone number without upgrading the proxy server, so that it avoids the problem of frequent upgrading for equipments caused by new application protocol's appearance, increases the adaptability to the upgrading of application protocols, decreases the network rebuilding cost, increases the flexibility of the management for terminals, and improves the service serving level and the user's feelings.

### FIELD OF THE INVENTION

The present invention relates to a method for acquiring user terminal information in the wireless communication network, and more particularly to a method for ensuring the service platform the acquisition of the user terminal information under multiple application protocols, which belongs to the technical field of communication technology.

### BACKGROUND OF THE INVENTION

The mobile network can only acquire the flow capacity information of the data service, and the user usage information of the data service, for instance the times of successful download, the number of pieces of message successfully sent and so on, can only be obtained from the service platform. Therefore, the billing based on the data service platform must take it into account that how to allow the service platform to acquire the user's cellphone number.

At present, the usual way is to add a proxy server in the mobile network. As shown in FIG. 1, when the user terminal establishes the connection with the network and the network assigns an IP address to the user terminal, the corresponding relationship between the IP address and the user terminal is accordingly set up in the proxy server. When the user terminal initiates the application layer service request, this request is firstly transmitted to the proxy server. The proxy server inserts the corresponding cellphone number into the data packet of the application protocol according to the corresponding relationship between the IP address and the user terminal, and subsequently transmits it to the corresponding service platform. Therefore, it can be ensured that the service platform can acquire the user's cellphone number and carry out the billing for the data service.

Because of the large number of the application layer protocols of data service, the proxy server must be able to support multiple application protocols in order to accomplish inserting the user's cellphone number into the data packages of different application protocols. If a new protocol appears, the proxy server will need to be upgraded, which will cause great cost, complicated upgrading procedure and long engineering period, and urgently needs further improvement.

### SUMMARY OF THE INVENTION

An object of the present invention is to provide a method for ensuring the service platform the acquisition of the user terminal information under multiple application protocols, wherein by adding the step of sending the general application protocol request to the proxy server before the client terminal's normal service request, it is ensured that the service platform is still capable of acquiring user's cellphone number without upgrading the proxy server, so that it avoids the problem of frequent upgrading for equipments caused by new application protocol's appearance.

The problem to be solved of the present invention is achieved by following technical solution:

a method for ensuring the service platform the acquisition of the user terminal information under multiple application protocols, wherein the a client terminal service connection software is set in the user terminal or the user card, said client terminal service connection software has a service connection user interface and is able to inspect and control the mobile service connection carried out by the mobile terminal;

said method comprises the following steps: the user establishes the service request on the mobile terminal; the mobile terminal sends the connection establishment request to the mobile network; the mobile network assigns an IP address to the user, and sets up the corresponding relationship between the IP address and the user's cellphone number after it has received the connection establishment request; the mobile network sends the corresponding relationship between the IP address and the user's cellphone number to the proxy server; the proxy server sends the response information to the mobile network after it has received the corresponding relationship between the IP address and the user's cellphone number; the mobile network sends the response information of the connection successfully established to the mobile terminal, and sends the IP address assigned to the user to the mobile terminal after the mobile network has received the response information of the proxy server; the mobile terminal initiates the general application protocol request to the mobile network; the mobile network transmits the received general application protocol request to the proxy server; the proxy server inserts the corresponding cellphone number into the data package of the general application protocol request according to the corresponding relationship between the IP address and the user's cellphone number after it has received the general application protocol request; the proxy server transmits the data package of the general application protocol request including the corresponding cellphone number to the service platform; after the service platform received the data package of the general application protocol request, sends the response information to the proxy server; the proxy server transfers the response information to the mobile network; the mobile network transfers the response information to the mobile terminal; the mobile terminal determines whether the connection is established successfully after it has received the response information; if not, go to the step 7; if so, the next step follows; the mobile terminal sends the service request to the mobile network; the mobile network transmits the service request to the service platform after it has received the service request.

By adding the step of sending the general application protocol request to the proxy server before the client terminal's normal service request, the present invention ensures that the service platform is still capable of acquiring user's cellphone number without upgrading the proxy server, so that it avoids the problem of frequent upgrading for equipments caused by new application protocol's appearance, solves the problem how to allow the service platform to acquire the user's cellphone number for billing on the condition of new protocol's appearance without upgrading the proxy server, enhances the billing capability of the network operator, decreases the billing cost, increases the adaptability to upgrading of the application protocols, reduces the network rebuilding cost, increases the flexibility of the management for terminals, and improves the service serving level and the user's feelings.

### BRIEF DESCRIPTION OF THE DRAWINGS

FIG. 1 is the work flow chart of the prior art.

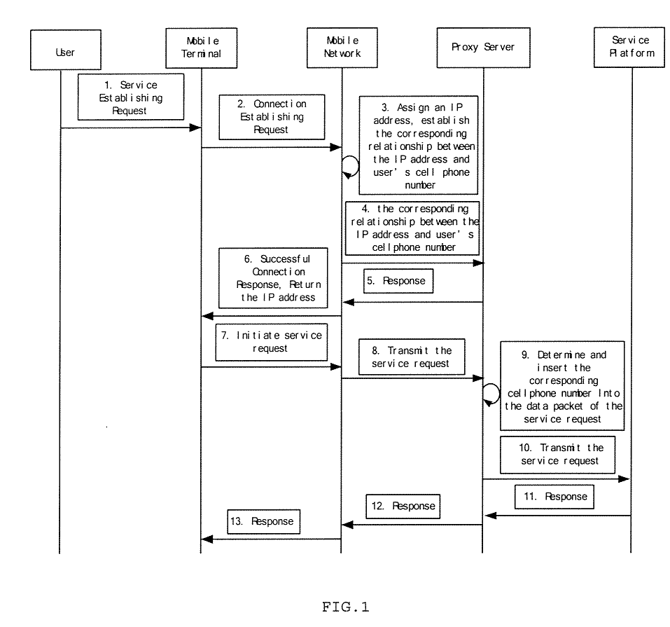

FIG. 2 is the sketch illustrating the system architecture of the present invention.

FIG. 3 is the work flow chart of the embodiment of the present invention.

### DETAILED DESCRIPTION OF THE PREFERRED EMBODIMENTS

The solution provided by the present invention will be better understood from the following detailed description of preferred embodiments of the present invention referring to the drawings.

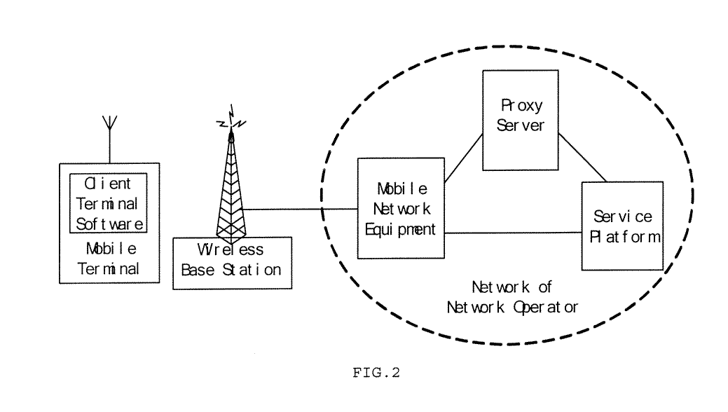

FIG. 2 illustrates the system architecture of the present invention, which comprises the mobile terminal, the wireless base station and the network of operator, wherein the network of operator comprises the mobile network equipment, the proxy server, and the service platform, with the mobile network equipment comprising the mobile gateway and so on. The wireless base station is connected with the mobile network equipment by cable, and the mobile network equipment is connected with the proxy server and the service platform by cable. The wireless base station receives information from and sends information to the mobile terminal wirelessly, and the information of the mobile terminal is delivered by the wireless base station to the mobile network equipment by cable and afterwards is delivered by the mobile network equipment to the proxy server and the service platform by cable. Meanwhile, the wireless base station receives the response information sent by the proxy server and the service platform for the mobile terminal through the mobile network equipment. The client terminal service connection software is set in the mobile terminal or the user card, which comprises the service connection user interface and is able to inspect and control the mobile service connection carried out by the mobile terminal.

According to the present invention, it is required that the mobile terminal and the service platform must be able to support not only the corresponding service application protocols such as the SIP protocol, the RTP protocol and so on, but also a general application protocol, for instance the HTTP protocol. However, the proxy server only needs to support the general application protocol for instance the HTTP protocol, and there is no need for the proxy server to provide additional support to the new service application protocol according to the new service's appearance, which avoids the frequent upgrading of the proxy server due to the new service application protocol's appearance.

In the present invention, the client terminal service connection software is set in the user terminal or the user card, which comprises the service connection user interface and is able to inspect and control the mobile service connection carried out by the mobile terminal. The client terminal program sends the general application protocol request to the proxy server before initiating the service request, and the proxy server inserts the cellphone number into the data packet of the general application protocol and then transmits the data packet to the service platform. In the present invention, by adding the step of sending the general application protocol request to the proxy server before the client terminal's normal service request, it is ensured that the service platform is still capable of acquiring the user's cellphone number without upgrading the proxy server, so that it avoids the problem of frequent upgrading for equipments caused by new application protocol's appearance. It should be pointed out that the general application protocol request additionally transmitted to the proxy server before the client terminal initiates normal service request, is automatically transmitted by the client terminal without user's involvement, and won't cause any inconvenience to the user in terms of process and procedure.

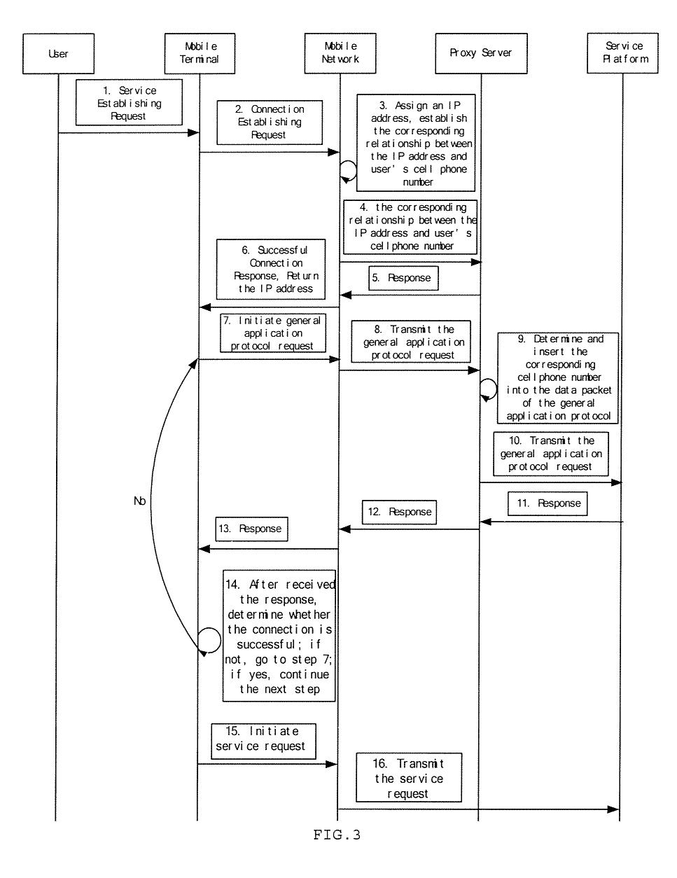

As shown in FIG. 3, it illustrates a work flow chart of an embodiment of the present invention, which is a method for ensuring the service platform the acquisition of the user terminal information under multiple application protocols comprises following steps:

Step 1: the user establishes the service request on the mobile terminal;

Step 2: the mobile terminal sends the connection establishment request to the mobile network;

Step 3: the mobile network assigns an IP address to the user, and sets up the corresponding relationship between the IP address and the user's cellphone number after it has received the connection establishment request;

Step 4: the mobile network sends the corresponding relationship between the IP address and the user's cellphone number to the proxy server;

Step 5: the proxy server sends the response information to the mobile network after it has received the corresponding relationship between the IP address and the user's cellphone number;

Step 6: the mobile network sends the response information of the connection successfully established to the mobile terminal, and sends the IP address assigned to the user to the mobile terminal after it has received the response information of the proxy server;

Step 7: the mobile terminal initiates the general application protocol request to the mobile network and begins to time simultaneously; if, the mobile terminal doesn't receive the response that the service platform has already successfully obtained the user's cellphone number returned from the mobile network within the set waiting period T, the mobile terminal compares the times m of the initiated general application protocol request with the set maximal pushing times N; if m is less than N, the step 7 is repeated; if m equals N, the mobile terminal displays the connection failure information on the screen to inform the user; wherein the waiting period T is set by the mobile terminal, and the maximal pushing time N is at least twice and is set by the mobile terminal;

Step 8: the mobile network transmits the received general application protocol request to the proxy server;

Step 9: the proxy server inserts the corresponding cellphone number into the data package of the general application protocol request according to the corresponding relationship between the IP address and the user's cellphone number after it has received the general application protocol request;

Step 10: the proxy server transmits the data package of the general application protocol request including the corresponding cellphone number to the service platform;

Step 11: the service platform sends the response information to the proxy server after it has received the data package of the general application protocol request;

Step 12: the proxy server transfers the response information to the mobile network;

Step 13: the mobile network transfers the response information to the mobile terminal;

Step 14: the mobile terminal determines whether the connection is established successfully after it has received the response information; if yes, the next step follows; if not, the mobile terminal compares the times m of the initiated general application protocol request with the set maximal pushing times N; if m is less than N, go to the step 7; if m equals N, the mobile terminal displays the connection failure information on the screen to inform the user; wherein the waiting period T is set by the mobile terminal, and the maximal pushing times N is at least twice and is set by the mobile terminal;

Step 15: the mobile terminal sends the service request to the mobile network; and

Step 16: the mobile network transmits the service request to the service platform after it has received the service request.

For example, a user initiates the mobile chatting service request which adopts the SIP protocol, but the proxy server only supports the HTTP protocol and can only parse the HTTP protocol.

After receiving the service request sent by the user, the mobile chatting client terminal program initiates the connection establishment request to the mobile network immediately. After receiving this request, the mobile gateway assigns an IP address to the user, establishes the corresponding relationship between the IP address and the user's cellphone number, and sends this corresponding relationship to the proxy server so that the proxy server acquires the corresponding relationship between the IP address and the user's cellphone number, and then sends a response to the mobile gateway. The mobile gateway returns the assigned IP address to the terminal after receiving the response.

The terminal initiates the HTTP request automatically after receiving the response. After receiving the request, the proxy server parses the HTTP protocol, inserts the user's cellphone number corresponding to this IP address into the field of the HTTP protocol's packet head, and then transmits this HTTP request to the mobile chatting service platform. Because the HTTP protocol belongs to a general application protocol, the service platform can parse the HTTP's packet head and reads the user's cellphone number. Therefore, the service platform can bill for the service usage of the user based on the user's cellphone number.

After finishing the above operations, the service platform sends a response to the terminal. After receiving the response, the terminal determines whether the connection is successful; if not, the terminal resends the HTTP request; and it is not until the terminal receives the success response that the client terminal program begins the chatting service and initiates the SIP protocol request.

Finally, it should be understood that the above embodiments are only used to explain, but not to limit the technical solution of the present invention. In despite of the detailed description of the present invention with referring to above preferred embodiments, it should be understood that various modifications, changes or equivalent replacements can be made by those skilled in the art without departing from the spirit and scope of the present invention and covered in the claims of the present invention.

What is claimed is:

1. A method for ensuring the service platform the acquisition of the user terminal information under multiple application protocols, characterized in that a client terminal service connection software is set in the user terminal or the user card, said client terminal service connection software has a service connection user interface and is able to inspect and control the mobile service connection carried out by the mobile terminal, and said method comprises the following steps:
Step 1: the user establishes the service request on the mobile terminal;
Step 2: the mobile terminal sends the connection establishment request to the mobile network;
Step 3: the mobile network assigns an IP address to the user, and sets up the corresponding relationship between the IP address and the user's cellphone number after it has received the connection establishment request;
Step 4: the mobile network sends the corresponding relationship between the IP address and the user's cellphone number to the proxy server;
Step 5: the proxy server sends the response information to the mobile network after it has received the corresponding relationship between the IP address and the user's cellphone number;
Step 6: the mobile network sends the response information of the connection successfully established to the mobile terminal, and sends the IP address assigned to the user to the mobile terminal after the mobile network has received the response information of the proxy server;
Step 7: the mobile terminal initiates the general application protocol request to the mobile network;
Step 8: the mobile network transmits the received general application protocol request to the proxy server;
Step 9: the proxy server, inserts the corresponding cellphone number into the data package of the general application protocol request according to the corresponding relationship between the IP address and the user's cellphone number after it has received the general application protocol request;
Step 10: the proxy server transmits the data package of the general application protocol request including the corresponding cell phone number to the service platform;
Step 11: the service platform sends the response information to the proxy server after it has received the data package of the general application protocol request;
Step 12: the proxy server transfers the response information to the mobile network;
Step 13: the mobile network transfers the response information to the mobile terminal;
Step 14: the mobile terminal determines whether the connection is established successfully after it has received the response information; if not, go to the step 7; if yes, the next step follows;
Step 15: the mobile terminal sends the service request to the mobile network; and
Step 16: the mobile network transmits the service request to the service platform after it has received the service request.

2. The method for ensuring the service platform the acquisition of the user terminal information under multiple application protocols as claimed in claim 1, characterized in that said step 7 specifically comprises that:
the mobile terminal initiates the general application protocol request to the mobile network and begins to time simultaneously; if, the mobile terminal doesn't receive the response that the service platform has already successfully obtained the user's cellphone number returned from the mobile network within the set waiting period T, the mobile terminal compares the times m of the initiated general application protocol request with the set maximal pushing times N; if m is less than N, the step 7 is repeated; if m equals N, the mobile terminal displays the connection failure information on the screen to inform the user.

3. The method for ensuring the service platform the acquisition of the user terminal information under multiple application protocols as claimed in claim 2, characterized in that said waiting period T is set by the mobile terminal.

4. The method for ensuring the service platform the acquisition of the user terminal information under multiple application protocols as claimed in claim 2, characterized in that said maximal pushing times N is at least twice and is set by the mobile terminal.

5. The method for ensuring the service platform the acquisition of the user terminal information under multiple application protocols as claimed in claim 1, 2, 3 or 4, characterized in that said step 14 specifically comprises that:
after the mobile terminal has received the response information, the mobile terminal determines whether the connection is established successfully; if yes, the next step follows; if not, the mobile terminal compares the times m of the initiated general application protocol request with the set maximal pushing times N; if m is less than N, go to the step 7; if m equals N, the mobile terminal displays the connection failure information on the screen to inform the user.

6. The method for ensuring the service platform the acquisition of the user terminal information under multiple application protocols as claimed in claim 5, characterized in that said waiting period T is set by the mobile terminal.

7. The method for ensuring the service platform the acquisition of the user terminal information under multiple application protocols as claimed in claim 5, characterized in that said maximal pushing times N is at least twice and is set by the mobile terminal.
